(19) United States
(12) Patent Application Publication
(10) Pub. No.: US 2016/0187913 A1
(43) Pub. Date: Jun. 30, 2016

(54) POWER SUPPLY SYSTEM

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: JUN-YI DENG, Wuhan (CN); CHUN-SHENG CHEN, New Taipei (TW)

(21) Appl. No.: 14/671,189

(22) Filed: Mar. 27, 2015

(30) Foreign Application Priority Data
Dec. 25, 2014 (CN) 201410819139.9

(51) Int. Cl. G05F 3/24

(52) U.S. Cl. CPC G05F 3/24

(57) ABSTRACT

A power supply system for an electronic device includes a first interface, a first switch, and a second switch. When the electronic device is not connected to the first interface, the switch circuit receives a first voltage level switch control signal based upon output of the first interface, the first switch turns on and outputs a second voltage level power control signal to the second switch, the second switch turns off and does not provide power to the electronic device via the first interface. When the electronic device is connected to the first interface, the switch circuit receives a second voltage level switch control signal based upon output of the first interface, the first switch turns off and outputs a first voltage level power control signal to the second switch, the second switch turns on and provides power supply to the electronic device via the first interface.

### CROSS-REFERENCE TO RELATED APPLICATIONS

This application claims priority to Chinese Patent Application No. 201410819139.9 filed on Dec. 25, 2014, the contents of which are incorporated by reference herein in its entirety.

### FIELD

The subject matter herein generally relates to a power supply system.

### BACKGROUND

Printed circuit boards (PCBs) usually have slots for inserting memory chips. Users can insert one or more memory chips in the slots as required. When some of the slots are empty, dusts and other conductive objects may drop in the slots and cause short circuit on the PCB.

### BRIEF DESCRIPTION OF THE DRAWINGS

Implementations of the present technology will now be described, by way of example only, with reference to the attached figures.

FIG. 1 is a block diagram of an embodiment of a power supply system.

FIG. 2 is a circuit diagram of the power supply system of FIG. 1, with the electronic device disconnected from the first interface.

FIG. 3 is a circuit diagram of the power supply system of FIG. 1, with the electronic device connected to the first interface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

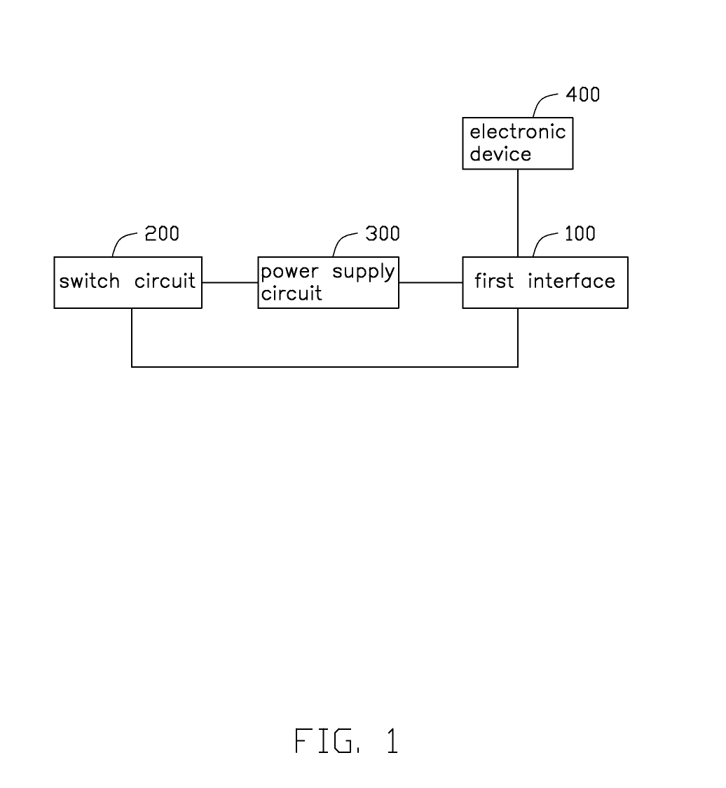

FIG. 1 illustrates a power supply system in accordance with one embodiment. The power supply system includes a first interface 100, a switch circuit 200, and a power supply circuit 300. The first interface 100 is used to connect with an electronic device 400. The power supply circuit 300 provides power supply to the electronic device 400 via the first interface 100. In at least one embodiment, the electronic device 400 is a memory chip.

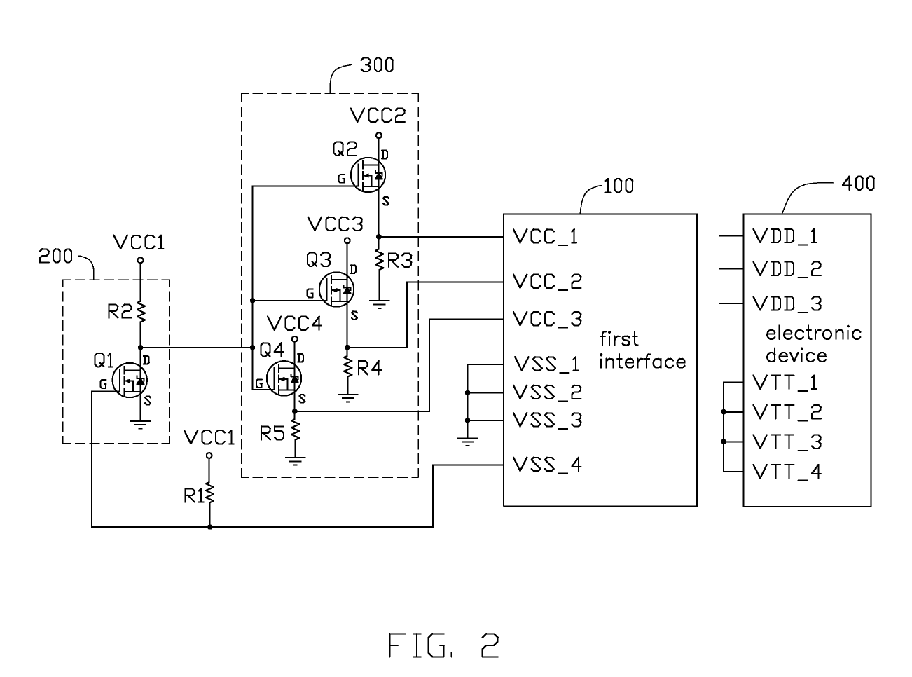

FIG. 2 illustrates that the first interface 100 includes a number of first data terminals VSS_1, VSS_2, VSS_3, a second data terminal VSS_4, and a number of power terminals VCC_1, VCC_2, VCC_3. Each of first data terminals VSS_1, VSS_2, VSS_3 is grounded. The second data terminal VSS_4 receives a first direct current (DC) voltage VCC1 via a first resistor R1. A connection point between the second data terminal VSS_4 and the first resistor R1 outputs a switch control signal to switch circuit 200. In at least one embodiment, the first DC voltage VCC1 is a +3 volts auxiliary voltage, although the invention is not so limited.

The switch circuit 200 includes a first switch Q1 and a second resistor R2. The first switch Q1 includes a first terminal, a second terminal, and a third terminal. In at least one embodiment, the first switch Q1 is an n channel MOSFET. The first terminal, the second terminal, and the third terminal of the first switch Q1 are gate, source, and drain respectively.

The first terminal of the first switch Q1 is electrically coupled to the connection point between the second data terminal VSS_4 and the first resistor R1, and receives the switch control signal. The second terminal of the first switch Q1 is grounded. The third terminal of the first switch Q1 receives the first DC voltage VCC1 via the second resistor R2. The third terminal of the first switch Q1 outputs a power control signal.

The power supply circuit 300 includes a second switch Q2, a third switch Q3, a fourth switch Q4, a third resistor R3, a fourth resistor R4, and a fifth resistor R5. Each of the second switch Q2, the third switch Q3, and the fourth switch Q4 includes a first terminal, a second terminal, and a third terminal. In at least one embodiment, the second switch Q2, the third switch Q3, and the fourth switch Q4 are n channel MOSFETs. The first terminal, the second terminal, and the third terminal of each of the second switch Q2, the third switch Q3, and the fourth switch Q4 are gate, source, and drain respectively.

The first terminals of the second switch Q2, the third switch Q3, and the fourth switch Q4 are electrically coupled to the third terminal of the first switch Q1. The second terminals of the second switch Q2, the third switch Q3, and the fourth switch Q4 are grounded via the third resistor R3, the fourth resistor R4, and the fifth resistor R5 respectively. The second terminals of the second switch Q2, the third switch Q3, and the fourth switch Q4 are electrically coupled to the number of power terminals VCC_1, VCC_2, VCC_3 respectively. The third terminals of the second switch Q2, the third switch Q3, and the fourth switch Q4 receive a second DC voltage VCC2, a third DC voltage VCC3, and a fourth DC voltage VCC4 respectively.

The electronic device 400 includes a number of first data pins VTT_1, VTT_2, VTT_3, a second data pin VTT_4, and a number of power pins VDD_1, VDD_2, VDD_3. Each of the first data pins VTT_1, VTT_2, VTT_3 is electrically coupled to the second data pin VTT_4.

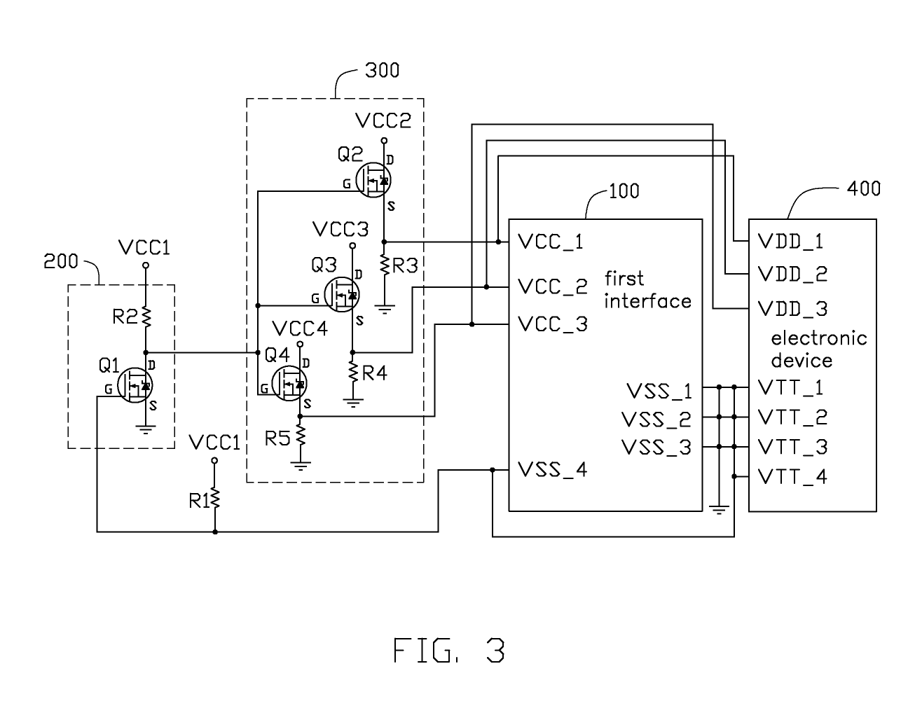

FIG. 3 illustrates that in use, when the electronic device 400 is connected to the first interface 100, the number of first data pins VTT_1, VTT_2, VTT_3 are connected to the number of first data terminals VSS_1, VSS_2, VSS_3 respectively, the second data pin VTT_4 is connected to the second data terminal VSS_4, and the number of power pins VDD_1, VDD_2, VDD_3 are connected to the number of power terminals VCC_1, VCC_2, VCC_3 respectively. The first data terminals VSS_1, VSS_2, VSS_3 is connected to the second data terminal VSS_4. A voltage level of the second data terminal VSS_4 is pulled down to a low voltage level by the number of first data terminals VSS_1, VSS_2, VSS_3. The connection point between the second data terminal VSS_4 and the first resistor R1 outputs a low voltage level switch control signal to the first terminal of the first switch Q1. The first switch Q1 turns off. The third terminal of the first switch Q1 outputs a high voltage level power control signal to the first terminals of the second switch Q2, the third switch Q3, and the fourth switch Q4. The second switch Q2, the third switch Q3, and the fourth switch Q4 turn on. The number of power terminals VCC_1, VCC_2, VCC_3 receives the second DC voltage VCC2, the third DC voltage VCC3, and the fourth DC voltage VCC4 via the second switch Q2, the third switch Q3, and the fourth switch Q4 respectively. The second DC voltage VCC2, the third DC voltage VCC3, and the fourth DC voltage VCC4 provide power supply to the electronic device 400 via the first interface 100.

FIG. 2 illustrates that in use, when the electronic device 400 is not connected to the first interface 100, the number of first data terminals VSS_1, VSS_2, VSS_3 is not connected to the second data terminal VSS_4. A voltage level of the second data terminal VSS_4 is pulled up to a high voltage level by the +3 volts first DC voltage VCC1 and the first resistor R1. The connection point between the second data terminal VSS_4 and the first resistor R1 outputs a high voltage level switch control signal to the first terminal of the first switch Q1. The first switch Q1 turns on. The third terminal of the first switch Q1 outputs a low voltage level power control signal to the first terminals of the second switch Q2, the third switch Q3, and the fourth switch Q4. The second switch Q2, the third switch Q3, and the fourth switch Q4 turn off. The number of power terminals VCC_1, VCC_2, VCC_3 cannot receive the second DC voltage VCC2, the third DC voltage VCC3, and the fourth DC voltage VCC4 via the second switch Q2, the third switch Q3, and the fourth switch Q4 respectively. The second DC voltage VCC2, the third DC voltage VCC3, and the fourth DC voltage VCC4 does not provide power supply to the electronic device 400 via the first interface 100. A short circuit is prevented when dust and other conductive objects drop in the empty first interface 100.

The embodiments shown and described above are only examples. Many details are often found in the art such as the other features of a power supply system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A power supply system comprising:
a first interface configured to connect with an electronic device;
a switch circuit comprising a first switch; and
a power supply circuit comprising a second switch and configured to provide power supply to the electronic device via the first interface;
wherein when the electronic device is not connected to the first interface, the switch circuit receives a first voltage level switch control signal based upon output of the first interface, the first switch turns on and outputs a second voltage level power control signal to the second switch, the second switch turns off and does not provide power supply to the electronic device via the first interface; and
wherein when the electronic device is connected to the first interface, the switch circuit receives a second voltage level switch control signal based upon output of the first interface, the first switch turns off and outputs a first voltage level power control signal to the second switch, the second switch turns on and provides power supply to the electronic device via the first interface.

2. The power supply system of claim 1, wherein the first voltage level is a high voltage level, and the second voltage level is a low voltage level.

3. The power supply system of claim 1, wherein the first interface comprises a first data terminal and a second data terminal; the first data terminal is grounded; the second data terminal receives a first direct current (DC) voltage; the electronic device comprises a first data pin and a second data pin; the first data pin is electrically coupled to the second data pin; and when the electronic device is connected to the first interface, the first data pin is connected to the first data terminal, the second data pin is connected to the second data terminal, and the first data terminal is connected to the second data terminal.

4. The power supply system of claim 3, wherein the electronic device is a memory chip, and the first DC voltage is a +3 volts auxiliary voltage.

5. The power supply system of claim 3, wherein the first interface further comprises a power terminal, each of the first switch and the second switch comprises a first terminal, a second terminal, and a third terminal, the first terminal of the first switch is electrically coupled to the second data terminal; the second terminal of the first switch is grounded, the third terminal of the first switch receives the first DC voltage, the third terminal of the first switch is coupled to the first terminal of the second switch; the second terminal of the second switch is grounded, the second terminal of the second switch is electrically coupled to the power terminal, and the third terminal of the second switch receives a second DC voltage.

6. The power supply system of claim 5, wherein the electronic device further comprises a power pin, and when the electronic device is connected to the first interface, the power pin is connected to the power terminal.

7. The power supply system of claim 5, wherein the first switch and the second switch are n channel MOSFETs, and the first terminal, the second terminal, and the third terminal are gate, source, and drain respectively.

8. A power supply system comprising:
a first interface configured to connect with an electronic device, the first interface comprises a first data terminal and a second data terminal, the electronic device comprises a first data pin and a second data pin;
the first data terminal being grounded; the second data terminal receives a first direct current (DC) voltage, the first data pin is electrically coupled to the second data pin;
a switch circuit comprising a first switch; and
a power supply circuit comprising a second switch and configured to provide power supply to the electronic device via the first interface;
wherein when the electronic device is not connected to the first interface, the switch circuit receives a first voltage level switch control signal based upon output of the first interface, the first switch turns on and outputs a second voltage level power control signal to the second switch, the second switch turns off and does not provide power supply to the electronic device via the first interface; and
wherein when the electronic device is connected to the first interface, the first data pin is connected to the first data terminal, the second data pin is connected to the second data terminal, and the first data terminal is connected to the second data terminal, the switch circuit receives a second voltage level switch control signal based upon output of the first interface, the first switch turns off and outputs a first voltage level power control signal to the second switch, the second switch turns on and provides power supply to the electronic device via the first interface.

9. The power supply system of claim 8, wherein the first voltage level is a high voltage level, and the second voltage level is a low voltage level.

10. The power supply system of claim 8, wherein the electronic device is a memory chip, and the first DC voltage is a +3 volts auxiliary voltage.

11. The power supply system of claim 8, wherein the first interface further comprises a power terminal, each of the first switch and the second switch comprises a first terminal, a second terminal, and a third terminal, the first terminal of the first switch is electrically coupled to the second data terminal; the second terminal of the first switch is grounded, the third terminal of the first switch receives the first DC voltage, the third terminal of the first switch is coupled to the first terminal of the second switch; the second terminal of the second switch is grounded, the second terminal of the second switch is electrically coupled to the power terminal, and the third terminal of the second switch receives a second DC voltage.

12. The power supply system of claim 11, wherein the electronic device further comprises a power pin, and when the electronic device is connected to the first interface, the power pin is connected to the power terminal.

13. The power supply system of claim 11, wherein the first switch and the second switch are n channel MOSFETs, and the first terminal, the second terminal, and the third terminal are gate, source, and drain respectively.

14. A power supply system comprising:
a first interface configured to connect with an electronic device;
a switch circuit comprising at least a first switch; and
a power supply circuit comprising at least a second switch and configured to provide power supply to the electronic device via the first interface;
wherein when the electronic device is disconnected from the first interface, the switch circuit receives a first voltage level switch control signal based upon output of the first interface, the at least one first switch turns on and outputs a first voltage level power control signal to the at least one second switch, and the at least one second switch turns off and does not provide power to the electronic device via the first interface; and
wherein when the electronic device is connected to the first interface, the switch circuit receives a second voltage level switch control signal based upon output of the first interface, the at least one first switch turns off and outputs a second voltage level power control signal to the at least one second switch, and the second switch turns on and provides power supply to the electronic device via the first interface.
